(19) United States
(12) Patent Application Publication
(10) Pub. No.: US 2010/0027524 A1
(43) Pub. Date: Feb. 4, 2010

(54) Radio layer emulation of real time protocol sequence number and timestamp

(75) Inventor: Luis Miguel Santos Barreto, Camberley (GB)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/221,319

(22) Filed: Jul. 31, 2008

(51) Int. Cl. H04J 3/00; H04L 12/66

(52) U.S. Cl. 370/345; 370/356

(57) ABSTRACT

A method for mapping CS voice data in a packet data channel is described. A CS plane voice data unit which includes a data unit header that has information indicative of a timestamp is generated. The data unit is transmitted over a packet data channel that introduces radio jitter (e.g., a packet switched data channel). The CS plane voice data unit is received and mapping of the data unit is provided based upon the timestamp information. The header may include information indicative of a SN. The timestamp information may be a part of an adaptation layer counter field and the SN may be a part of a packet data control protocol sequencing number field. Alternatively, the timestamp information a may be a part of a first protocol layer SN field and the SN may be a part of a second protocol layer SN field. Apparatus and computer programs are also described.

### TECHNICAL FIELD

The exemplary embodiments of this invention relate generally to wireless communication systems and, more specifically, relate to mapping circuit switched voice data.

### BACKGROUND

Certain abbreviations found in the description and/or in the Figures are herewith defined as follows:

3G third generation

3GPP Third Generation Partnership Project

AMR adaptive multi-rate

CS circuit switch

E-DCH enhanced dedicated channel

eNB E-UTRAN Node B

E-UTRA evolved UTRA

E-UTRAN evolved UTRAN

HS-DSCH high speed downlink shared channel

L2 layer 2 (the data link layer, e.g., the PDCP/RLC/MAC layer)

L3 layer 3 (the network layer, e.g., the RRC layer)

LTE long term evolution

MAC medium access control

Node-B base station

PDC-EFR personal digital cellular enhanced full rate

PDCP packet data convergence protocol

PDU protocol data unit

PHY physical (Layer 1 or L1)

PID packet identifier

RAN radio access network

RLC radio link control

RLC-UM radio link control unacknowledge mode

RNC radio network controller

RRC radio resource control

RTP real time protocol

SID silence insertion descriptor

SN sequence number

TDMA-EFR time division multiple access enhanced full rate

TSN transmission SN

UE user equipment

UMTS universal mobile telecommunications system

UTRA UMTS terrestrial radio access

UTRAN UMTS terrestrial radio access network

VoIP voice over IP

WB-AMR wide band AMR

A proposed communication system known as evolved UTRAN (E-UTRAN, also referred to as UTRAN-LTE) is at present a study item within the 3GPP.

The usage of HS-DSCH and E-DCH channels for CS voice introduces some jitter in the voice packets. This is a similar situation as when VoIP is used over the same channels; however, VoIP relies on real time protocol (RTP) headers to provide timestamps and sequence numbers. These RTP timestamps and sequence numbers enable the receiver to reorder and detect missing voice packets.

RTP is not currently available for the circuit switched plane voice data. Therefore, some solution based on the existing radio layers (MAC, RLC, PDCP) is required.

There is a need for mapping of CS data for channels that are traditionally used for packet switched data. There is also a need to provide a jitter buffer or adaptation layer for circuit switched AMR voice data.

### SUMMARY

An exemplary embodiment in accordance with this invention is a method for mapping circuit switched voice data in a packet data channel. The method includes generating a circuit switched plane voice data unit which includes a data unit header including information indicative of a timestamp. The data unit is transmitted over a packet data channel that introduces radio jitter (e.g., a packet switched data channel).

Another exemplary embodiment in accordance with this invention is a method for mapping circuit switched voice data in a packet data channel. The method includes receiving a circuit switched plane voice data unit including a counter value indicative of a timestamp over a packet data channel that introduces radio jitter. Mapping of the data unit is provided based upon the information indicative of a timestamp, and the counter value is delivered to an upper layer protocol.

A further exemplary embodiment in accordance with this invention is an apparatus for mapping circuit switched voice data in a packet data channel. The apparatus includes a processing unit. The processing unit is configured: to generate a circuit switched plane voice data unit including a data unit header including information indicative of a timestamp, and to prepare the data unit to be transmitted over a packet data channel that introduces radio jitter.

Another exemplary embodiment in accordance with this invention is an apparatus for mapping circuit switched voice data in a packet data channel. The apparatus includes a processing unit. The processing unit is configured to receive a circuit switched plane voice data unit including a data unit header including information indicative of a timestamp and to provide mapping of the data unit based upon the information indicative of a timestamp.

A further exemplary embodiment in accordance with this invention is an apparatus for mapping circuit switched voice data in a packet data channel. The apparatus includes a processor for generating a circuit switched plane voice data unit including information indicative of a timestamp. A transmitter for transmitting the data unit over a packet data channel is also included.

Another exemplary embodiment in accordance with this invention is an apparatus for mapping circuit switched voice data in a packet data channel. The apparatus includes a receiver for receiving a circuit switched plane voice data unit including information indicative of a timestamp over a packet data channel that introduces radio jitter. A processor for providing mapping of the data unit based upon the information indicative of a timestamp is also included.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a simplified block diagram of various electronic devices that are suitable for use in practicing the exemplary embodiments of this invention;

FIG. 2A depicts a simplified block diagram of an PDCP PDU for AMR in accordance with an exemplary embodiment of this invention where no header is used;

FIG. 2B depicts a simplified block diagram of another PDCP PDU for AMR in accordance with an exemplary embodiment of this invention where a new one octet long header is introduced;

FIG. 2C depicts a simplified block diagram of a further PDCP PDU for AMR in accordance with an exemplary embodiment of this invention where the PDU type and SID field are reused;

FIG. 2D depicts a simplified block diagram of another PDCP PDU for AMR in accordance with an exemplary embodiment of this invention where the PDU type and SID fields are reused;

FIG. 2E depicts a simplified block diagram of a further PDCP PDU for AMR in accordance with an exemplary embodiment of this invention where a new header structure is introduced;

FIG. 3 depicts a simplified block diagram of a protocol stack an accordance with an exemplary embodiment of this invention;

FIG. 4 depicts another simplified block diagram of a protocol stack an accordance with an exemplary embodiment of this invention; and

FIG. 5 illustrates an exemplary embodiment of this invention which provides a method for providing radio layer emulation of real time protocol sequence numbers and timestamps.

### DETAILED DESCRIPTION

An exemplary embodiment in accordance with this invention relates to mapping circuit switched voice data in 3GPP over UTRA channels that are traditionally associated with packet switched data (e.g., HS-DSCH and E-DCH). The nature of these channels and the way the packet switched data works in UTRAN introduces jitter to the CS data. Since CS voice data may rely on a near constant delivery of packets (e.g., every 20 ms), a jitter buffer and reordering may be used in a user equipment (UE) and the network (e.g., RNC). Exemplary embodiments of this invention reuse the information available at RAN protocol layers (e.g., MAC, RLC, PDCP) for usage in a jitter buffer and adaptation layer of the CS place voice codec.

Exemplary embodiments of this invention also allow for the reuse of existing parameters and header fields to implement a jitter buffer and adaptation layer usable for CS data.

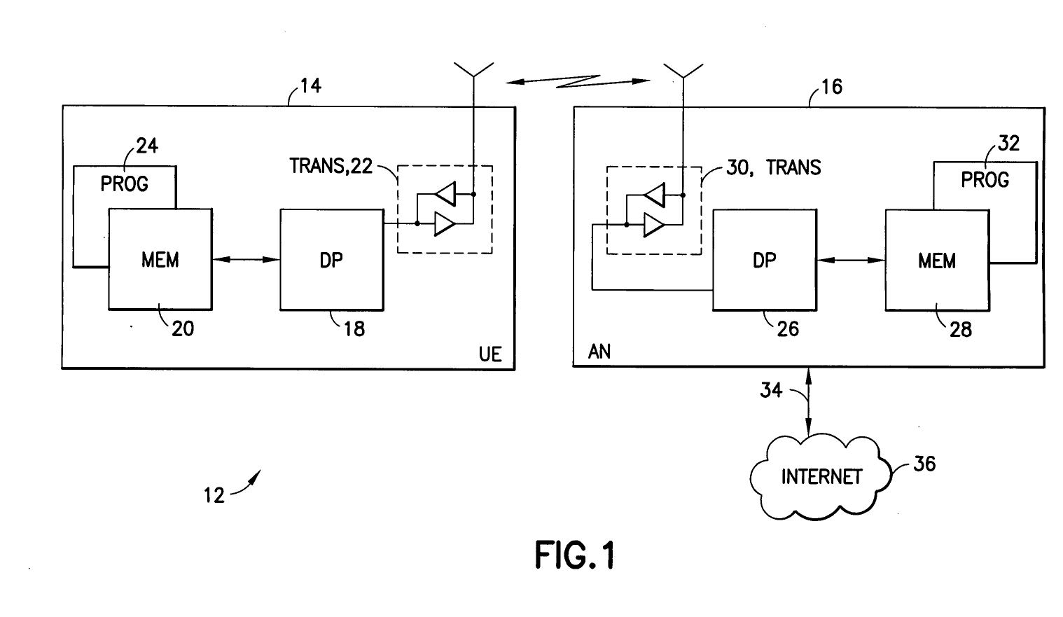

Reference is made to FIG. 1 for illustrating a simplified block diagram of various electronic devices that are suitable for use in practicing the exemplary embodiments of this invention. In FIG. 1, a wireless network 12 is adapted for communication with a user equipment (UE) 14 via an access node (AN) 16. The UE 14 (sometimes referred to as a subscriber station (SS) or mobile station (MS)) includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 may have multiple antennas to facilitate communication.

The AN 16 (which may be a base station (BS)) includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, cellular phones, personal digital assistants (PDAs) having wireless communication capabilities, portable computers having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi core processor architecture, as non limiting examples.

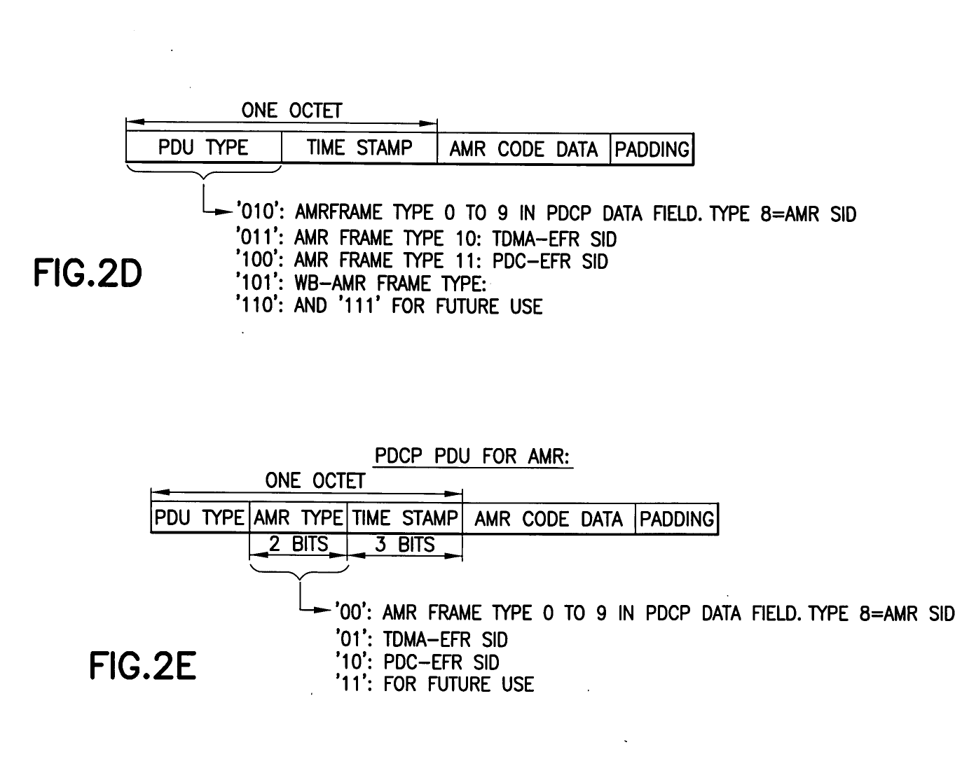

FIG. 3 depicts a simplified block diagram of exemplary protocol stacks 420 and 425 such as used for E-UTRAN (see 3GPP TS 36.300 V8.3.0 (2007-12)). The stacks shows the protocol layers for the UE (stack 420) and BS (stack 425). As shown, each stack includes a RRC layer, a PDCP layer 430 and 435, a RLC layer, a MAC layer and a PHY layer.

Exemplary embodiments of this invention emulate the usage of a RTP timestamp and sequence number in the RAN layers based on using a protocol layer sequence numbering for a timestamp and a second protocol layer underneath it for the circuit switched packet (e.g. AMR voice frame) sequence number.

Traditionally the radio layers (e.g. RLC) increment their packet sequence number when a packet is transmitted. In an exemplary embodiment of this invention, the same protocol layer would increment the value of the sequence number to be transmitted (for the next packet) at a given time (e.g., when the packet arrives at the RLC, or when it is transmitted).

In addition, the transmitter side may transmit any packets that actually represent either a speech frame or a silent frame while not transmitting other frame type packets (e.g., Narrow Band AMR frame type 15 packets are not transmitted).

In an exemplary embodiment of this invention an adaptation layer may be introduced above the PDCP that has a counter which is incremented for each time period. The counter value and the voice packet may be concatenated. The receiver may use this counter as a timestamp, and use MAC sequence numbers (e.g., TSN), RLC-UM sequence numbers (e.g., SN) or PDCP sequence numbers to detect any gaps in the packet transmissions. This keeps the PDCP, RLC and MAC layers transparent to upper layer activity.

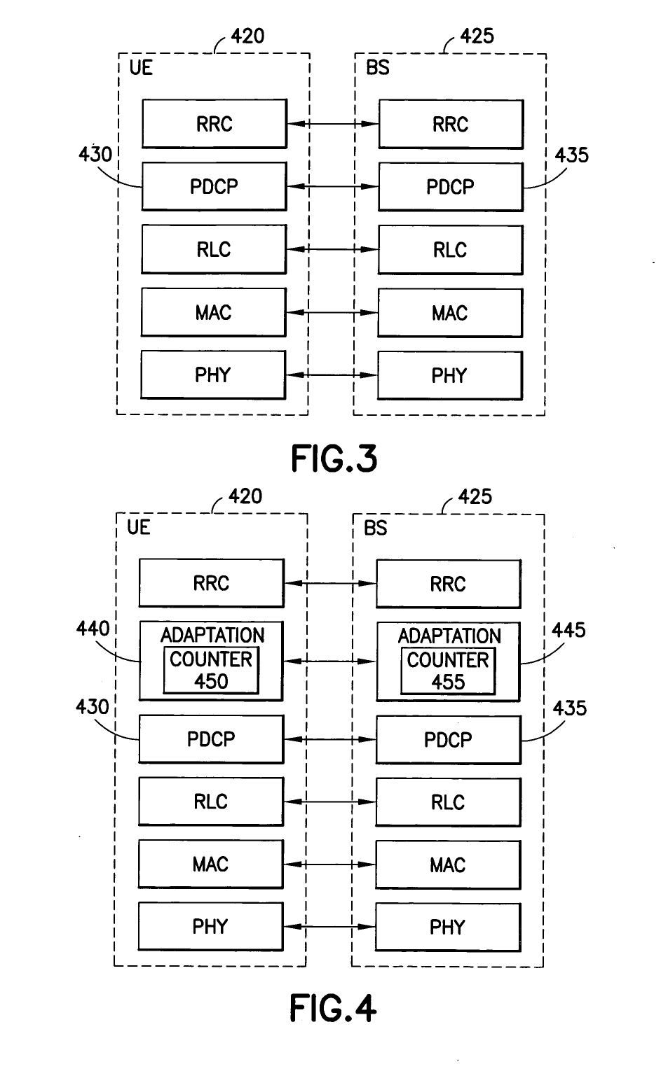

FIG. 4 shows exemplary protocol stacks with an adaptation layer (440 and 445) above the PDCP layer. In a non-limiting example, each adaptation layer (440 and 445) includes a counter (450 and 455).

In another exemplary embodiment of this invention a PDCP Sequence Number may be used as a timestamp. The PDCP may increase the value of the SN expected for the next packet for each time period. If the packet received from upper layers is not delivered to RLC (e.g., the packet contains an AMR Frame Type 15), but the Sequence Number is still increased (PDCP Sequence Number emulates the RTP timestamp). Every packet delivered to RLC may also have an RLC Sequence Number associated, which is increased with every transmission (RLC Sequence Number emulates RTP Sequence Number). Using this embodiment, the RLC and MAC layers are transparent to upper layer activity.

The PDCP SN is currently 16 bits which may be excessive for some applications. Therefore, it would be possible to use less then the 16 bits of the SN for such purposes (e.g., 8 bits).

Some of the unused PDCP “PDU Type” header field (e.g., the last 3 bits) and the normal packet length may be used to identify the type of AMR PDU and replace the PDCP “PID” header field with a timestamp field that would use the same number of bits. The principle of operation is still the same however; it allows a minimization of the PDCP header overhead. The RLC and MAC layers are transparent to upper layer activity.

Since the receiving PDCP unit can deduce the AMR frame number from the size of the PDCP data field, the following PDCP header types are possible: no header, an octet long header and a header which reuses the PDU type and SID fields.

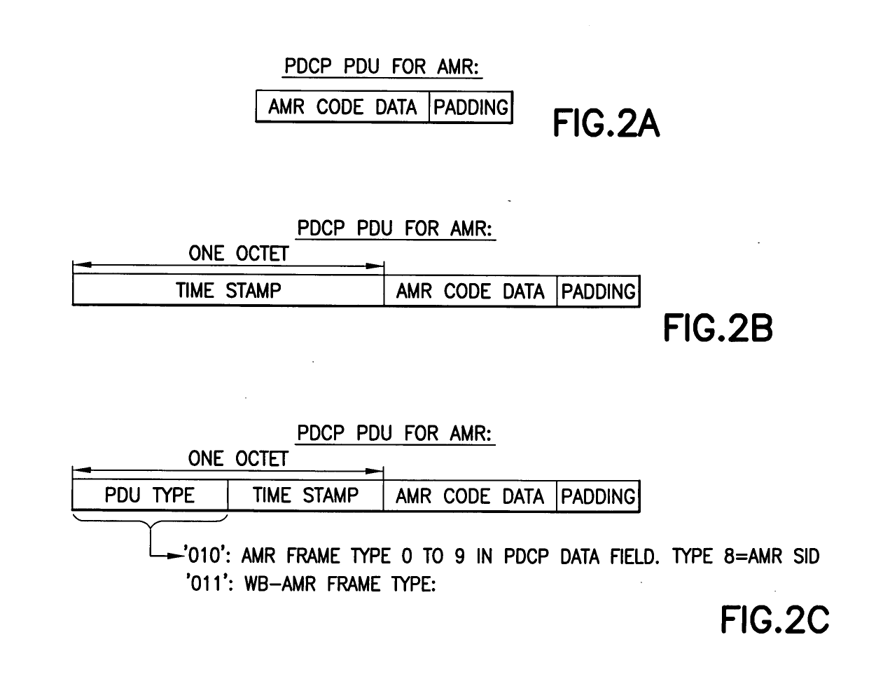

FIG. 2A shows a sample PDCP PDU for AMR where no header is used. The PDCP performs padding to achieve octet alignment of the AMR core data. The sequence number and timestamp may be provided by lower layers, as described below. The use of AMR or WB-AMR is provided when configuring the PDCP entity.

FIG. 2B shows another sample PDCP PDU for AMR where a new, one-octet long header is introduced. This header contains a timestamp. The RLC-UM sequence number may be used to detect lost AMR core data. The use of AMR or WB-AMR is provided when configuring the PDCP entity.

In FIG. 2C, a further sample PDCP PDU for AMR is shown, where the PDU type and SID field are reused. Non-used PDU type values may be used to identify the transmission of AMR or WB-AMR data. The SID field is used to carry timestamp information.

Most of the AMR core data (e.g., class A, B, and C bits, SID or no_data) has a unique size when octet aligned. Thus the receiving side can determine the AMR frame number based on the size of the data field. The use of a particular silence descriptors may be indicated when distinguishing between different silence descriptors. Sequence numbers for lost data detection may also be provided in the RLC layer.

As shown in FIG. 2D the PDU type and SID fields are reused. The PDU type may indicate the use of either: AMR, TDMA-EFR SID, PDC-EFR SID or WB-AMR. If AMR is used, the size of the PDCP data field may uniquely identify the AMR frame number and the amount of padding bits added at the transmitting side. In the currently proposed standard, there are a number of unused PDU type values which may be used to signal this information.

FIG. 2E shows a further sample PDCP PDU for AMR where a new header structure is introduced. The PDU type may be used to signal AMR or WB-AMR being transmitted in the PDCP data field. The PID field is replaced by a two bits field indicating the SID type and a 3 bit field provides a timestamp.

In a further exemplary embodiment of this invention RLC sequence numbers may be used as the timestamp. The transmitter RLC-UM may identify relevant AMR voice packets which are not to be transmitted. The RLC-UM Sequence Number may be increased for each time period (e.g., 20 ms). Thus, the RLC-UM SN emulates a RTP timestamp. The receiver side may use MAC sequence numbers (e.g., TSN) to identify missing packets (MAC reordering queue TSN emulates the RTP Sequence Number). This embodiment keeps MAC transparent to upper layer activity.

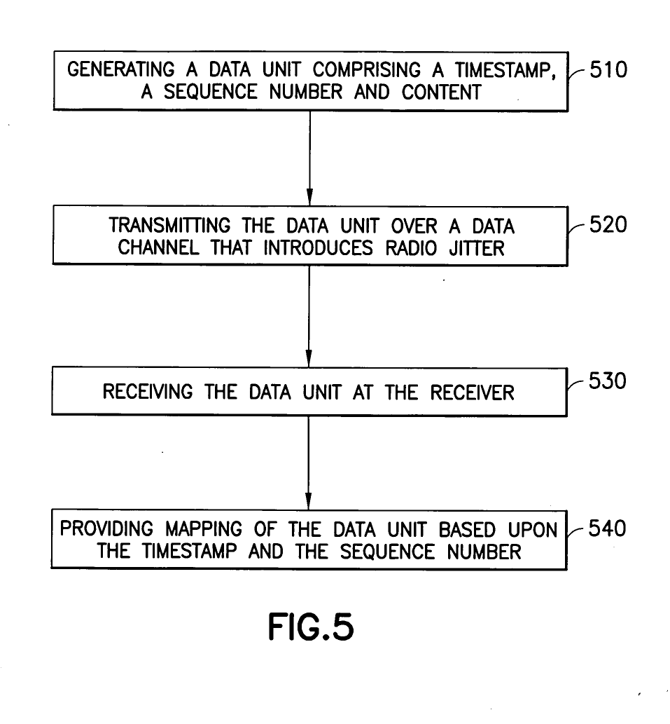

FIG. 5 illustrates an exemplary embodiment of this invention which provides a method for providing radio layer emulation of real time protocol sequence numbers and timestamps. In step 510, a data unit comprising information indicative of a timestamp, a sequence number and content is generated. The data unit is transmitted over a packet data channel that introduces radio jitter (e.g., a packet switched data channel) in step 520. At step 530, the data unit is received by the receiver. Mapping of the data unit is provided based upon the timestamp and the sequence number in step 540.

An exemplary embodiment in accordance with this invention is a method for mapping circuit switched voice data in a packet data channel. The method includes generating a circuit switched plane voice data unit which includes a data unit header including information indicative of a timestamp. The data unit is transmitted over a packet data channel that introduces radio jitter (e.g., a packet switched data channel).

In a further exemplary embodiment of the method above, the data unit header also includes information indicative of a sequence number and the information indicative of a timestamp includes at least a part of an adaptation layer counter field. The information indicative of the sequence number includes at least a part of a packet data control protocol sequencing number field.

In another exemplary embodiment of the method above, the data unit header also includes information indicative of a sequence number. The information indicative of a timestamp includes at least a part of a first protocol layer sequencing number field and the information indicative of the sequence number includes at least a part of a second protocol layer sequencing number field.

In a further exemplary embodiment of the method above, the first protocol layer sequencing number field is a packet data control protocol sequencing number field and the second protocol layer sequencing number field is a radio link control sequencing number field.

In another exemplary embodiment of the method above, a packet data control protocol header field also includes an adaptive multi-rate packet data unit identifier. The packet data control protocol sequencing number field includes at least a part of the packet data control protocol header.

In a further exemplary embodiment of the method above, the first protocol layer sequencing number field is a radio link control sequencing number field and the second protocol layer sequencing number field is a medium access control sequencing number field.

In another exemplary embodiment of any one of the methods above, the information indicative of a timestamp is a counter value and the counter is periodically incremented. The counter may be incremented every 20 ms.

In a further exemplary embodiment of the method above, the packet data channel is a shared channel or a dedicated channel.

In another exemplary embodiment of any one of the methods above, the data unit also includes a speech frame or a silent frame generated by a speech encoder.

In a further exemplary embodiment of any one of the methods above, the method is performed as a result of execution of computer program instructions stored in a computer readable memory medium.

Another exemplary embodiment in accordance with this invention is a method for mapping circuit switched voice data in a packet data channel. The method includes receiving a circuit switched plane voice data unit including information indicative of a timestamp over a packet data channel that introduces radio jitter. Mapping of the data unit is provided based upon the information indicative of a timestamp.

In a further exemplary embodiment of the method above, the data unit header also includes information indicative of a sequence number. The information indicative of a timestamp includes at least a part of an adaptation layer counter field and the information indicative of the sequence number includes a at least part of a packet data control protocol sequencing number field.

In another exemplary embodiment of the method above, the data unit header also includes information indicative of a sequence number. The information indicative of a timestamp includes at least a part of a first protocol layer sequencing number field and the information indicative of the sequence number includes a part of a second protocol layer sequencing number field.

In a further exemplary embodiment of the method above, the first protocol layer sequencing number field is a packet data control protocol sequencing number field and the second protocol layer sequencing number field is a radio link control sequencing number field.

In another exemplary embodiment of the method above, a packet data control protocol header field also includes an adaptive multi-rate packet data unit identifier. The packet data control protocol sequencing number field includes at least a part of the packet data control protocol header.

In a further exemplary embodiment of the method above, the first protocol layer sequencing number field is a radio link control sequencing number field and the second protocol layer sequencing number field is a medium access control sequencing number field. The sequence number field may be delivered to an upper layer protocol.

In another exemplary embodiment of any one of the methods above, the information indicative of a timestamp is a counter value. The counter value may be delivered to an upper layer protocol.

In a further exemplary embodiment of any one of the methods above, the packet data channel is a high speed downlink shared channel and/or an enhanced dedicated channel.

In another exemplary embodiment of any one of the methods above, the data unit also includes a speech frame or a silent frame generated by a speech encoder.

In a further exemplary embodiment of any one of the methods above, the mapping of the data unit is used to provide a jitter buffer.

In another exemplary embodiment of any one of the methods above, the mapping of the data unit is used to identify missing data units.

In a further exemplary embodiment of any one of the methods above, the method is performed as a result of execution of computer program instructions stored in a computer readable memory medium.

Another exemplary embodiment in accordance with this invention is an apparatus for mapping circuit switched voice data in a packet data channel. The apparatus includes a processing unit (which may include one or more processors). The processing unit is configured: to generate a circuit switched plane voice data unit including a data unit header including information indicative of a timestamp, and to prepare the data unit to be transmitted over a packet data channel that introduces radio jitter.

In a further exemplary embodiment of the apparatus above, the data unit header also includes information indicative of a sequence number. The information indicative of a timestamp includes at least a part of a first protocol layer field; and the information indicative of the sequence number includes at least a part of a second protocol layer sequencing number field.

In another exemplary embodiment of the apparatus above, the first protocol layer sequencing number field is a radio link control sequencing number field and the second protocol layer sequencing number field is a medium access control sequencing number field.

In a further exemplary embodiment of the apparatus above, the data unit header also includes information indicative of a sequence number and the information indicative of a timestamp is a counter value. The processing unit is also configured to periodically increment the counter value.

Another exemplary embodiment in accordance with this invention is an apparatus for mapping circuit switched voice data in a packet data channel. The apparatus includes a processing unit. The processing unit is configured to receive a circuit switched plane voice data unit including a data unit header including information indicative of a timestamp and to provide mapping of the data unit based upon the information indicative of a timestamp.

In a further exemplary embodiment of the apparatus above, the data unit header also includes information indicative of a sequence number. The information indicative of a timestamp includes at least a part of a first protocol layer sequencing number field and the information indicative of the sequence number includes at least a part of a second protocol layer sequencing number field.

In another exemplary embodiment of the apparatus above, the first protocol layer sequencing number field is a radio link control sequencing number field and the second protocol layer sequencing number field is a medium access control sequencing number field.

In a further exemplary embodiment of any one of the apparatus above, the information indicative of a timestamp is a counter value.

In another exemplary embodiment of any one of the apparatus above, the mapping of the data unit is used to provide a jitter buffer.

A further exemplary embodiment in accordance with this invention is an apparatus for mapping circuit switched voice data in a packet data channel. The apparatus includes means for generating a circuit switched plane voice data unit including information indicative of a timestamp. Means for transmitting the data unit over a packet data channel are also included.

In another exemplary embodiment of the apparatus above, the generating means is a processing unit and the transmitting means is a transmitter.

A further exemplary embodiment in accordance with this invention is an apparatus for mapping circuit switched voice data in a packet data channel. The apparatus includes means for receiving a circuit switched plane voice data unit including information indicative of a timestamp over a packet data channel that introduces radio jitter. Means for providing mapping of the data unit based upon the information indicative of a timestamp is also included.

In another exemplary embodiment of the apparatus above, the receiving means is a receiver and the providing means is a processing unit.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

While the exemplary embodiments have been described above in the context of the E-UTRAN system, it should be appreciated that the exemplary embodiments of this invention are not limited for use with only this one particular type of wireless communication system, and that they may be used to advantage in other wireless communication systems.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
generating a data unit comprising a data unit header comprising information indicative of a timestamp;
transmitting the data unit over a packet data channel that introduces radio jitter,
where the data unit is a circuit switched plane voice data unit.

2. The method of claim 1, wherein the data unit header further comprises information indicative of a sequence number and wherein the information indicative of a timestamp comprises at least a part of an adaptation layer counter field and the information indicative of the sequence number comprises at least a part of a packet data control protocol sequencing number field.

3. The method of claim 1, wherein the data unit header further comprises information indicative of a sequence number and wherein the information indicative of a timestamp comprises at least a part of a first protocol layer sequencing number field; and the information indicative of the sequence number comprises at least a part of a second protocol layer sequencing number field.

4. The method of claim 3, wherein the first protocol layer sequencing number field is a packet data control protocol sequencing number field and the second protocol layer sequencing number field is a radio link control sequencing number field.

5. The method of claim 4, wherein a packet data control protocol header field further comprises an adaptive multi-rate packet data unit identifier;
wherein the packet data control protocol sequencing number field comprises at least a part of the packet data control protocol header.

6. The method of claim 3, wherein the first protocol layer sequencing number field is a radio link control sequencing number field and the second protocol layer sequencing number field is a medium access control sequencing number field.

7. The method of claim 1, wherein the information indicative of a timestamp is a counter value, wherein the counter is periodically incremented.

8. The method of claim 7, wherein the counter is incremented every 20 ms.

9. The method of claim 1, wherein the packet data channel is one of a shared channel and a dedicated channel.

10. The method of claim 1, wherein the data unit further comprises one of a speech frame and a silent frame generated by a speech encoder.

11. The method of claim 1, performed as a result of execution of computer program instructions stored in a computer readable memory medium.

12. A method comprising:
receiving a data unit over a packet data channel that introduces radio jitter, wherein the data unit is a circuit switched plane voice data unit and comprises a header that comprises a counter value indicative of a timestamp;
providing mapping of the data unit based upon the counter value; and
delivering the counter value to an upper layer protocol.

13. The method of claim 12, wherein the data unit header further comprises a packet data control protocol sequencing number field and an adaptation layer counter field, wherein information indicative of a sequence number is disposed within the packet data control protocol sequencing field and the counter value is disposed within the adaptation layer counter field.

14. The method of claim 12, further comprises decoding, in one of a radio link control protocol layer or a medium access control protocol layer, a sequence number that is disposed within a first protocol layer sequencing number field of the data unit header;
and wherein delivering the counter value to the upper layer protocol comprises delivering the counter value and the sequence number to the upper layer protocol, further comprising decoding the counter value in one of a radio link control protocol layer, a medium access control protocol layer a packet data convergence protocol layer, an adaptation protocol layer and a radio resource control protocol layer, wherein the counter value is disposed in a second protocol layer sequencing number field of the data unit header.

15. The method of claim 14, wherein the second protocol layer sequencing number field is a packet data control protocol sequencing number field and the first protocol layer sequencing number field is a radio link control sequencing number field.

16. The method of claim 15, wherein the data unit header further comprises a packet data control protocol header field in which is disposed an adaptive multi-rate packet data unit identifier and the second protocol layer sequencing number field in which the counter value is disposed.

17. The method of claim 14, wherein the first protocol layer sequencing number field is a radio link control sequencing number field and the second protocol layer sequencing number field is a medium access control sequencing number field or a radio link control sequencing number field.

18. The method of claim 12, wherein the packet data channel is at least one of a high speed downlink shared channel and an enhanced dedicated channel.

19. The method of claim 12, wherein the data unit further comprises one of a speech frame and a silent frame generated by a speech encoder.

20. The method of claim 12, wherein the mapping of the data unit is used to provide a jitter buffer or to identify at least one missing data unit.

21. The method of claim 12, performed as a result of execution of computer program instructions stored in a computer readable memory medium.

22. An apparatus comprising:
a processing unit, where the processing unit is configured:
to generate a data unit comprising a data unit header comprising information indicative of a timestamp, and
to prepare the data unit to be transmitted over a packet data channel that introduces radio jitter,
where the data unit is a circuit switched plane voice data unit.

23. The apparatus of claim 22, wherein the data unit header further comprises information indicative of a sequence number and wherein the information indicative of the sequence number comprises at least a part of a first protocol layer field; and the information indicative of the timestamp comprises at least a part of a second protocol layer sequencing number field.

24. The apparatus of claim 23, wherein the second protocol layer sequencing number field is a radio link control sequencing number field and the first protocol layer sequencing number field is one of a medium access control sequencing number field or a radio link control sequencing number field.

25. The apparatus of claim 22, wherein the data unit header further comprises information indicative of a sequence number and wherein the information indicative of a timestamp is a counter value, and wherein the processing unit is further configured to periodically increment the counter value.

26. An apparatus comprising:
a processing unit, where the processing unit is configured:
to receive a data unit comprising a data unit header comprising information indicative of a timestamp; and
to provide mapping of the data unit based upon the information indicative of a timestamp,
where the data unit is a circuit switched plane voice data unit.

27. The apparatus of claim 26, wherein the data unit header further comprises information indicative of a sequence number and wherein the information indicative of the sequence number comprises at least a part of a first protocol layer sequencing number field; and the information indicative of the timestamp comprises at least a part of a second protocol layer sequencing number field.

28. The apparatus of claim 27, wherein the second protocol layer sequencing number field is a radio link control sequencing number field and the first protocol layer sequencing number field is one of a medium access control sequencing number field and a radio link control sequencing number field.

29. The apparatus of claim 26, wherein the information indicative of a timestamp is a counter value and
the mapping of the data unit is used to provide a jitter buffer.

30. An apparatus comprising:
a processor for generating a data unit comprising information indicative of a timestamp; and
a transmitter for transmitting the data unit over a packet data channel,
where the data unit is a circuit switched plane voice data unit.

31. An apparatus comprising:
a receiver for receiving a data unit comprising information indicative of a timestamp over a packet data channel that introduces radio jitter; and
a processor for providing mapping of the data unit based upon the information indicative of a timestamp,
where the data unit is a circuit switched plane voice data unit.
